(19) United States
(12) Patent Application Publication
(10) Pub. No.: US 2008/0086575 A1
(43) Pub. Date: Apr. 10, 2008

(54) NETWORK INTERFACE TECHNIQUES

(76) Inventors: Annie Foong, Aloha, OR (US); Bryan Veal, Hillsboro, OR (US)

Correspondence Address: CAVEN & AGHEVLI;c/o INTELLEVATE, P.O. BOX 52050, MINNEAPOLIS, MN, 55402, US

(21) Appl. No.: 11/539,510

(22) Filed: Oct. 6, 2006

(51) Int. Cl. G06F 15/16

(52) U.S. Cl. 709/250

(57) ABSTRACT

Techniques are described that can be used to implement a network interface. A network interface may be communicatively coupled to a general purpose core or hardware thread. Various operations can be assigned to be performed by the general purpose core, thereby at least to provide flexible operation of the network interface. The general purpose core may be capable to issue inter-processor interrupts to other cores or hardware threads to request processing. The other cores or hardware threads may respond to inter-processor interrupts by executing one or more interrupt service routine. The other cores or hardware threads may be capable to process network protocol units received by the network interface.

### FIELD

The subject matter disclosed herein relates to techniques to implement a network interface.

### RELATED ART

Protocols used in communications systems are continually evolving. Network interfaces have the capability to transmit signals to a network and receive signals from a network. It is desirable to provide a network interface with the flexibility to be modified at least to support evolving protocols.

### BRIEF DESCRIPTION OF THE DRAWINGS

Embodiments of the present invention are illustrated by way of example, and not by way of limitation, in the drawings and in which like reference numerals refer to similar elements.

FIG. 1 depicts an example system embodiment in accordance with some embodiments of the present invention.

FIGS. 2 and 3 depict example elements that can be used in some embodiments of the present invention at least to provide communication between a network interface and one or more target core.

FIG. 4 depicts example elements that can be used in some embodiments of the present invention.

FIG. 5 depicts example elements that can be used in some embodiments of the present invention to support processing of network protocol units by multiple target cores.

FIG. 6 depicts an example process that can be used in some embodiments of the present invention.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

The evolving requirements of network interface devices may call for programmability of the network interface device or a replacing the device with another device which meets the requirements. New capabilities can be implemented in software, but in certain situations, it may be preferable to minimize changes to the device driver, such as with legacy drivers or virtualization. Current competitive pressures include adding protocol-specific optimizations to high-speed network interfaces such as Transmission Control Protocol (TCP) header/payload splitting and TCP segmentation offload. The optimizations typically have the network interface understand packet header format and size. Knowledge of the most typical protocol headers is typically hardwired in the network interface, and only a limited number of protocols can be supported on any one product. It may be desirable for network interfaces at least to be flexible enough to be capable of modification to support evolving protocols while minimizing changes to the device driver.

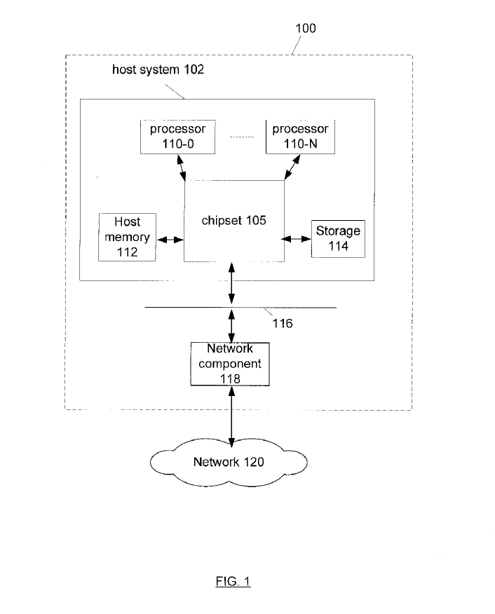

FIG. 1 depicts in computer system 100 a suitable system in which some embodiments of the present invention may be used. Computer system 100 may include host system 102, bus 116, and network component 118.

Host system 102 may include chipset 105, processors 110-0 to 110-N, host memory 112, and storage 114. Chipset 105 may provide intercommunication among processors 110-0 to 110-N, host memory 112, storage 114, bus 116, as well as a graphics adapter that can be used for transmission of graphics and information for display on a display device (both not depicted). For example, chipset 105 may include a storage adapter (not depicted) capable of providing intercommunication with storage 114. For example, the storage adapter may be capable of communicating with storage 114 in conformance at least with any of the following protocols: Small Computer Systems Interface (SCSI), Fibre Channel (FC), and/or Serial Advanced Technology Attachment (S-ATA).

In some embodiments, chipset 105 may include data mover logic (not depicted) capable to perform transfers of information within host system 102 or between host system 102 and network component 118. As used herein, a “data mover” refers to a module for moving data from a source to a destination without using the core processing module of a host processor, such as any of processor 110-0 to 110-N, or otherwise does not use cycles of a processor to perform data copy or move operations. By using the data mover for transfer of data, the processor may be freed from the overhead of performing data movements, which may result in the host processor running at much slower speeds. A data mover may include, for example, a direct memory access (DMA) engine. In some embodiments, data mover may be implemented as part of any of processor 110-0 to 110-N, although other components of computer system 100 may include the data mover. In some embodiments, data mover may be implemented as part of chipset 105.

Any of processors 110-0 to 110-N may be implemented as Complex Instruction Set Computer (CISC) or Reduced Instruction Set Computer (RISC) processors, a hardware thread, or any other microprocessor or central processing unit. Host memory 112 may be implemented as a volatile memory device such as but not limited to a Random Access Memory (RAM), Dynamic Random Access Memory (DRAM), or Static RAM (SRAM). Storage 114 may be implemented as a non-volatile storage device such as but not limited to a magnetic disk drive, optical disk drive, tape drive, an internal storage device, an attached storage device, flash memory, battery backed-up synchronous DRAM (SDRAM), and/or a network accessible storage device.

Bus 116 may provide intercommunication among at least host system 102 and network component 118 as well as other peripheral devices (not depicted). Bus 116 may support serial or parallel communications. Bus 116 may support node-to-node or node-to-multi-node communications. Bus 116 may at least be compatible with Peripheral Component Interconnect (PCI) described for example at Peripheral Component Interconnect (PCI) Local Bus Specification, Revision 3.0, Feb. 2, 2004 available from the PCI Special Interest Group, Portland, Oreg., U.S.A. (as well as revisions thereof); PCI Express described in The PCI Express Base Specification of the PCI Special Interest Group, Revision 1.0a (as well as revisions thereof); PCI-x described in the PCI-X Specification Rev. 1.1, Mar. 28, 2005, available from the aforesaid PCI Special Interest Group, Portland, Oreg., U.S.A. (as well as revisions thereof); and/or Universal Serial Bus (USB) (and related standards) as well as other interconnection standards.

Network component 118 may be capable of providing intercommunication between host system 102 and network 120 in compliance at least with any applicable protocols. Network component 118 may intercommunicate with host system 102 using bus 116. In one embodiment, network component 118 may be integrated into chipset 105. “Network component” may include any combination of digital and/or analog hardware and/or software on an I/O (input/output) subsystem that may process one or more packets to be transmitted and/or received over a network. In one embodiment, the I/O subsystem may include, for example, a network component card (NIC), and network component may include, for example, a MAC (media access control) layer of the Data Link Layer as defined in the Open System Interconnection (OSI) model for networking protocols. The OSI model is defined by the International Organization for Standardization (ISO) located at I rue de Varembe, Case postale 56 CH-1211 Geneva 20, Switzerland.

Network 120 may be any network such as the Internet, an intranet, a local area network (LAN), storage area network (SAN), a wide area network (WAN), or wireless network. Network 120 may exchange network protocol units with network component 118 using the Ethernet standard (described in IEEE 802.3 and related standards) or any communications standard. As used herein, a “network protocol unit” may include any packet or frame or other format of information with a header and payload portions formed in accordance with any protocol specification.

Some embodiments provide techniques to implement a network interface using a general purpose core or hardware thread that is communicatively coupled with a network interface. The combination of the network interface and general purpose core or hardware thread can appear to other cores or hardware threads as a single network interface. The general purpose core or hardware thread associated with the network interface may issue inter-processor interrupts (IPI) to one or more other target core or target hardware thread. The target core or target hardware thread may process the IPI as it would a device interrupt.

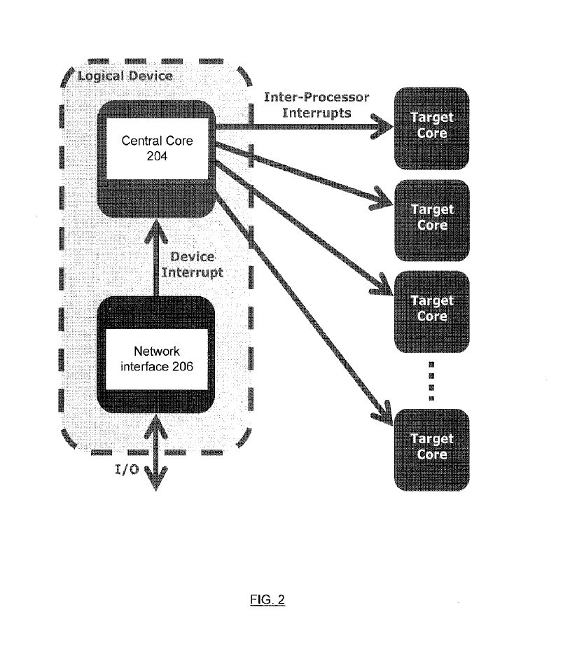

FIG. 2 depicts example elements that can be used in some embodiments of the present invention. Central core 204 may be a general-purpose core flexible enough to perform a variety of tasks on an input/output stream. In some embodiments, central core 204 may be a general-purpose core and/or a hardware thread. A general-purpose core may be an individual processing package containing a single set of physical execution units. A core may share a die with more cores such as in a dual core or multi-core environment. Use of a general purpose core may permit capabilities of network interface 206 to be modified at least using software. In some embodiments, multiple network interfaces may be communicatively coupled to one or more central core. Multiple network interfaces may appear as a single logical network interface to other logic. A hardware thread (also known as a logical core) may be a logical instantiation of the set of execution units of a physical core. An operating system sees a hardware thread as a physical core. Each hardware thread can handle a single thread of execution (software thread) at a time. Multiple hardware threads therefore allow multiple software threads to share a (physical) core in an overlapping fashion. To permit this sharing, the core may duplicate the independent state of each thread, including register sets, program counters, and page tables.

In some embodiments, although not a necessary feature of any embodiment, using a general-purpose core or hardware thread may extend the functionality of the network interface to form a new logical device. In some embodiments, although not a necessary feature of any embodiment, the target cores may consider this logical device as hardware because the target cores may not discern between IPIs and device interrupts.

In some embodiments, central core 204 may be communicatively coupled with network interface 206 using a PCI, PCI-X, or PCI Express compliant bus, although other techniques may be used. Network interface 206 may communicate with central core 204 at least using interrupts, message signaled interrupts, or polling.

In some embodiments, central core 204 may perform tasks such as but not limited to: execute an interrupt service routine in response to receipt of an interrupt from the network interface 206; read descriptors from the primary descriptor ring; execute any user-provided code which may modify or classify incoming network protocol units; perform any user-specified network-related operation; assign a target core and its secondary descriptor ring based on a user-specified classification; copy a descriptor from the primary descriptor ring to the appropriate secondary descriptor ring; and/or remove the descriptor from the primary descriptor ring. Primary and secondary descriptor rings can be used to manage processing of received network protocol units by one or more target core.

In some embodiments, network interface 206 may perform tasks such as but not limited to: receive network protocol units from a physical link; copy portion(s) of received network protocol units into host memory via a transfer by a data mover; and/or raise an interrupt to central core 204.

In response to network interface 206 receiving a network protocol unit, network interface 206 may provide an interrupt to central core 204. However, interrupts from network interface 206 to central core 204 can be provided for other reasons. In some embodiments, in response to the interrupt, central core 204 may provide an interrupt to a target core (or hardware thread) using an inter-processor interrupt (IPI) to request processing of portion(s) of the received network protocol unit. An operating system (OS) executed by central core 204 may be programmed to interrupt any combination of cores or hardware threads using one or more IPI. The core or thread that receives the IPI may treat the IPI as a device interrupt such as by invoking an interrupt handler. The target core (or thread) may choose to drop, redirect, or combine interrupts based on decisions it makes about I/O traffic.

One or more target core may perform protocol processing tasks ordinarily performed by the central core, including but not limited to: (1) data link, network, and transport layer protocol processing, including but not limited to (a) determining which protocols are used by the network protocol unit, (b) determining whether the network protocol unit properly follows protocol specifications, (c) tracking the state of network transmissions (e.g., updating TCP sequence numbers), (d) transmitting responses to a transmitter of network protocol units (e.g., sending TCP acknowledgements), and/or (e) arranging data contained in network protocol units (e.g., reassembling data in TCP packets); (2) scheduling operation of an application which is waiting for data from the network, (3) routing network protocol units to another location; (4) filtering unwanted network protocol units, and/or (5) freeing for other uses the memory storing the network protocol units once processing is complete.

In some embodiments, using IPIs to act as device interrupts leaves central core 204 free to implement new functionality for network interface 206 while reducing changes in the interrupt service routine of the device driver of the target core. Because device drivers are typically equipped to use ISRs, it can be more convenient to use IPI to emulate ISRs. Changes (e.g., re-coding efforts) to the device driver's interrupt service routine can be reduced at least because it has been seamlessly modified to service IPIs as well as device interrupts.

In some embodiments, the combination of central core 204 and network interface 206 allows network interface resources to be available to system resources and vice versa. For example, target cores may have full access to network interface resources by access to host memory used by the combination. Not only may a combination of central core 204 and network interface 206 allow full accessibility to network interface resources, but it may also allow extensibility (up to the limits imposed by the system and platform, and not limited by any implementation of network interface 206). Extensibility may be an ability to add new features to an existing program with minimal disruption or change of existing code. For example, by copying only descriptors to target cores and not copying payload to target cores, extensibility may be achieved. An off-the-shelf implementation of network interface 206 may appear to other components as a fully programmable, resource-rich network interface.

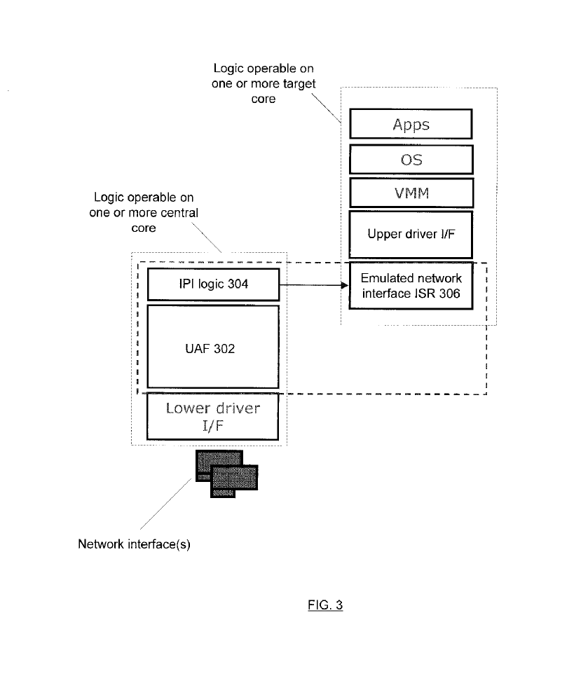

FIG. 3 depicts example elements that can be used in some embodiments of the present invention at least to provide communication between a network interface and a target core (or hardware thread). One or more network interface may generate interrupts to the lower driver interface (I/F). The lower driver interface accepts interrupts from one or more network interface and provides descriptors at least describing a storage location of received network protocol units in main memory. User-added functionality (UAF) stage 302 receives descriptors from lower driver interface. UAF 302 may determine which target core (or target hardware thread) is to receive an IPI and which secondary descriptor ring is to receive a descriptor associated with the received network protocol unit. UAF 302 may direct incoming network flows to appropriate core(s) or hardware thread(s) for processing. IPI logic 304 may generate an IPI for the appropriate hardware thread or target core based on a decision from UAF 302. For example. UAF 302 may decide which secondary ring and associated target core receives each descriptor and IPI logic 304 may request copying of each descriptor to the appropriate secondary ring. In some embodiments, using UAF 302 allows functionality in the higher layers to be better optimized. Accordingly, intelligent direction of IPIs to the correct target cores may be achieved. A general purpose core communicatively coupled to the network interface(s) (such as but not limited to central core 204) may execute any of lower driver interface, UAF 302, and IPI logic 304.

A target core or hardware thread may execute emulated network interface ISR 306. Emulated network interface ISR 306 may operate in response to receipt of an IPI from a central core or thread associated with one or more network interface. For example, emulated network interface ISR 306 may treat an IPI from a central core as an interrupt request. For example, emulated network interface ISR 306 may treat any IPI as an interrupt request. Interrupt requests for all devices may be mapped to interrupt vectors. Each vector may be assigned to a function which calls an interrupt service routine (ISR) to process the interrupt request.

In some embodiments, to allow the device driver's ISR to handle IPIs from another core, a device interrupt request may be assigned to identify the logical device and an ISR is dynamically assigned for this interrupt request by the device driver. Thus, at least two types of interrupts and their respective ISRs may be functionally equivalent to the original device interrupt and its ISR, but the IPI may now act as a proxy to trigger data processing in place of the original device interrupt.

For example, emulated network interface ISR 306 may perform an interrupt service routine to process a descriptor in response to receipt of an IPI from a central core or thread associated with one or more network interface. IPI logic 304 may request copying of descriptors into the secondary ring. However, other operations may be performed in response to receipt of an IPI. Emulated network interface ISR 306 may process the descriptor as if it came from a network interface. Emulated network interface ISR 306 may provide the descriptor and data to the upper driver interface (I/F). The upper driver interface may process the descriptor in the same manner as if it had come from the network interface directly. Upper driver interface may be an interface to a virtual machine migration (VMM) logic or an operating system (OS), or other logic. The target core or thread may execute one or more applications (shown as “Apps”). For example, an application may utilize data received in one or more network protocol unit.

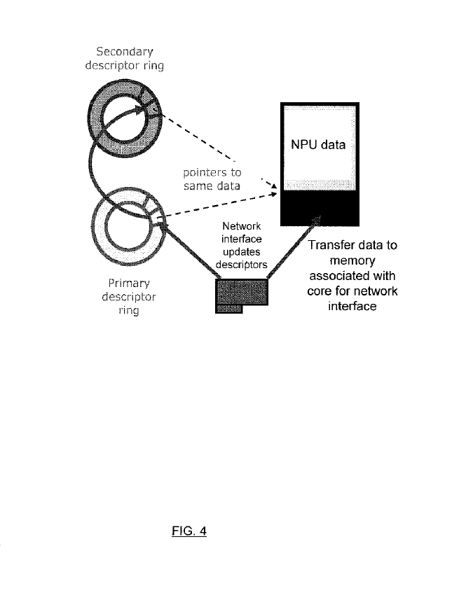

FIG. 4 depicts example elements that can be used in some embodiments of the present invention to manage processing of received network protocol units. A secondary descriptor ring can be used by each target core (or hardware thread) that can receive an IPI from the central core (or hardware thread) associated with the network interface. Logic executed by the central core (or hardware thread) associated with the network interface may populate the secondary descriptor ring with one or more descriptor common to the primary descriptor ring. The secondary descriptor ring may store the descriptors that are to be processed by the associated target core.

Memory associated with each target core (or hardware thread) may store an associated secondary descriptor ring. A central core (or hardware thread) associated with the network interface may manage storage of descriptors into each secondary descriptor ring. Data from received network protocol units can be stored in main memory accessible to the network interface. The target core may receive an IPI from the central core associated with the network interface and, in response, read a specified descriptor from an associated secondary descriptor ring. Based on descriptors in the associated secondary descriptor ring, the target core can copy data to memory associated with the target core and access such data.

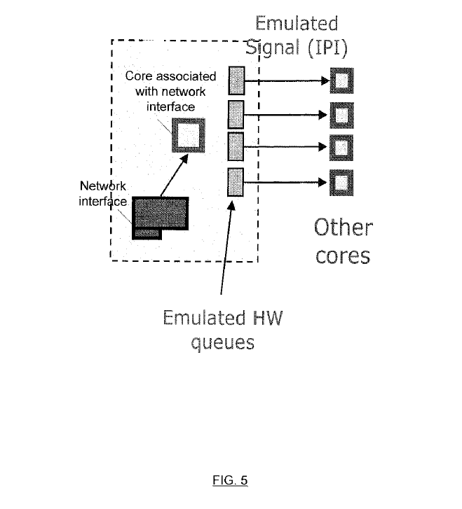

FIG. 5 depicts an example of elements that can be used in some embodiments of the present invention to support processing of received network protocol units by multiple cores or hardware threads. Streams received by a network interface can be allocated for processing by one or more target cores or hardware thread. To allocate a received network protocol unit for processing by a target core, a portion of the received network protocol unit may be stored in a memory queue (or region) associated with the target core. The central core (or hardware thread) associated with the network interface may decide how to allocate received network protocol units among the memory queues to allocate processing of received network protocol units among target cores. For example, receive side scaling techniques may be used to assign network protocol units for processing among target cores. Receive side scaling is described for example with regard to Network Driver Interface Specification (NDIS) 6.0 (2005) from Microsoft Corporation.

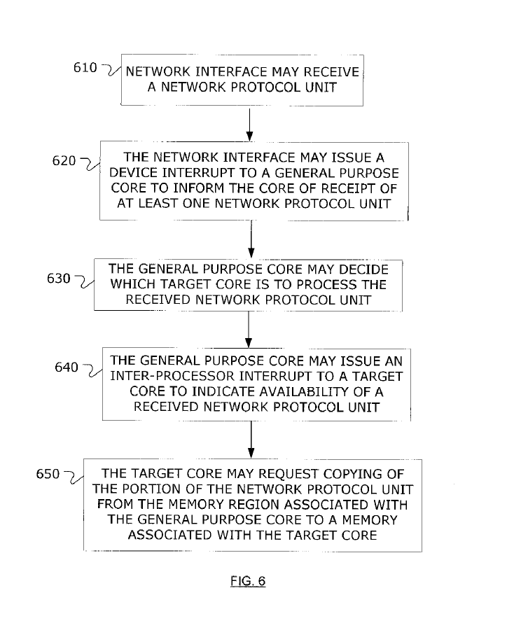

FIG. 6 depicts an example process that can be used in some embodiments of the present invention. In block 610, a network interface may receive a network protocol unit.

In block 620, the network interface may issue a device interrupt to a general purpose core to inform the core of receipt of at least one network protocol unit.

In block 630, the general purpose core may decide which target core is to process the received network protocol unit. For example, the decision may be made in part using receive side scaling techniques, although other techniques may be used. To assign a received network protocol unit to a target core, a descriptor associated with the received network protocol unit may be assigned to a secondary descriptor ring associated with the target core. The portion of the network protocol unit that is to be processed by the target core may be stored in a memory region associated with the general purpose core.

In block 640, the general purpose core may issue an inter-processor interrupt to a target core to indicate availability of a received network protocol unit. Logic executed or available to the target core may invoke an interrupt handler in response to the inter-processor interrupt.

In block 650, the target core may request copying of the portion of the network protocol unit from the memory region associated with the general purpose core to a memory associated with the target core. A descriptor in the secondary descriptor ring associated with the target core may identify the storage location of the portion of the network protocol unit.

Embodiments of the present invention may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. An apparatus comprising:
at least one network interface;
at least one target core;
a central core communicatively coupled to at least one network interface, wherein the central core is to selectively issue an inter-processor interrupt (IPI) to one or more target core in response to an interrupt from the network interface; and
a memory device communicatively coupled to the central core and at least one network interface.

2. The apparatus of claim 1, wherein at least one target core uses logic is to selectively perform an interrupt service routine in response to receipt of the IPI.

3. The apparatus of claim 1, wherein at least one network interface is capable to perform at least one operation selected from the group consisting of: receive network protocol units from a physical link, copy portion(s) of received network protocol units into the memory device, and raise an interrupt to the central core.

4. The apparatus of claim 1, wherein the central core is capable to perform at least one operation selected from the group consisting of: execute an interrupt service routine in response to receipt of an interrupt from the at least one network interface, read descriptors from a primary descriptor ring, execute any user-provided code to modify incoming network protocol units, execute any user-provided code to classify incoming network protocol units, assign a target core and a descriptor to its secondary descriptor ring based on a user-specified classification, copy a descriptor from the primary descriptor ring to the appropriate secondary descriptor ring, and remove the descriptor from the primary descriptor ring.

5. The apparatus of claim 1, further comprising:
a primary descriptor ring associated with at least one network interface; and
a secondary descriptor ring associated with at least one target core.

6. The apparatus of claim 5, further comprising:
logic to provide a descriptor in the primary descriptor ring to indicate one or more network protocol unit to process, wherein a portion of the one or more network protocol unit is stored in the memory device;
logic to allocate a target core to process the one or more network protocol unit; and
logic to provide a copy of a descriptor from the primary descriptor ring into a secondary descriptor ring associated with the allocated at least one target core.

7. The apparatus of claim 6, wherein:
the memory device is to store a payload of a received network protocol unit; and
the allocated at least one target core is to copy the payload from the memory device to a memory associated with the allocated at least one target core in response to a descriptor in a secondary descriptor ring associated with the allocated at least one target core requesting processing of the received network protocol unit.

8. The apparatus of claim 6, wherein the logic to allocate is to apply receive side scaling.

9. The apparatus of claim 1, wherein at least one target core is capable to perform at least one operation selected from the group consisting of: data link protocol processing, network layer protocol processing, transport layer protocol processing, scheduling operation of an application which is waiting for data from the network, routing network protocol units to another location, filtering unwanted network protocol units, and freeing for other uses the memory region storing the network protocol units.

10. The apparatus of claim 1, wherein the central core communicatively coupled to at least one network interface appears as a single logical device to one or more target core.

11. A method comprising:
receiving a network protocol unit;
issuing a device interrupt to a central core to inform the core of the receipt of the network protocol unit;
selecting a target core to process the received network protocol unit; and
selectively issuing an inter-processor interrupt to request processing of the network protocol unit to the selected target core.

12. The method of claim 11, wherein the selecting a target core comprises using receive side scaling techniques.

13. The method of claim 11, further comprising:
storing the network protocol unit into a main memory associated with the central core;
providing a descriptor that identifies the received network protocol unit in a primary descriptor ring;
providing the descriptor to a secondary ring associated with the selected target core.

14. The method of claim 13, further comprising:
the selected target core processing the descriptor; and
the selected target core requesting copying of a portion of the network protocol unit into a memory associated with the selected target core.

15. The method of claim 11, wherein the central core is capable to perform at least one operation selected from the group consisting of: execute an interrupt service routine in response to receipt of an interrupt from the at least one network interface, read descriptors from a primary descriptor ring, execute any user-provided code to modify incoming network protocol units, execute any user-provided code to classify incoming network protocol units, assign a target core and a descriptor to its secondary descriptor ring based on a user-specified classification, copy a descriptor from the primary descriptor ring to the appropriate secondary descriptor ring, and remove the descriptor from the primary descriptor ring.

16. The method of claim 11, wherein the target core is capable to perform at least one operation selected from the group consisting of: data link protocol processing, network layer protocol processing, transport layer protocol processing, scheduling operation of an application which is waiting for data from the network, routing network protocol units to another location, filtering unwanted network protocol units, and freeing for other uses the memory storing the network protocol units.

17. A system comprising:
a network medium;
a network interface communicatively coupled to the network medium;
a host system comprising:
at least one network interface;
at least one target core;
a central core communicatively coupled to at least one network interface, wherein the central core is to selectively issue an inter-processor interrupt (IPI) to one or more target core in response to an interrupt from the network interface; and
a memory device communicatively coupled to the central core and at least one network interface.

18. The system of claim 17, further comprising:
a primary descriptor ring associated with at least one network interface;
a secondary descriptor ring associated with at least one target core;
logic to provide a descriptor in the primary descriptor ring to indicate one or more network protocol unit to process, wherein a portion of the one or more network protocol unit is stored in the memory device;
logic to allocate at least one target core to process the one or more network protocol unit; and
logic to provide a copy of a descriptor from the primary descriptor ring into a secondary descriptor ring associated with allocated at least one target core.

19. The system of claim 18, wherein:
the memory device is to store a payload of a received network protocol unit, and
the allocated at least one target core is to copy the payload from the memory device to a memory associated with the allocated at least one target core in response to a descriptor in a secondary descriptor ring associated with the allocated at least one target core requesting processing of the received network protocol unit.

20. The system of claim 19, wherein the memory device is to include a buffer associated with at least one target core and wherein each buffer is to store portions of network protocol units to be processed by an associated target core.
